(19) United States
(12) Patent Application Publication
(10) Pub. No.: US 2019/0028045 A1
(43) Pub. Date: Jan. 24, 2019

(54) MOTOR DRIVE CONTROL DEVICE AND MOTOR DRIVE CONTROL METHOD

(71) Applicant: MINEBEA MITSUMI Inc., Nagano (JP)

(72) Inventor: Masato AOKI, Iwata-shi (JP)

(21) Appl. No.: 16/032,146

(22) Filed: Jul. 11, 2018

(30) Foreign Application Priority Data
Jul. 21, 2017 (JP) 2017-142084

(51) Int. Cl. H02P 6/22; H02P 23/20; H02P 25/026; H02P 6/24; H02P 6/15; H02P 6/16

(52) U.S. Cl. CPC H02P 6/22; H02P 23/20; H02P 6/16; H02P 6/24; H02P 6/15; H02P 25/026

(57) ABSTRACT

Provided is a motor drive control device capable of activating a motor in a particular direction rapidly and reliably even when an abnormal condition (in the abnormal condition the motor is rotated in reverse) has occurred. The control circuit unit is configured to output a drive control signal to the motor drive unit to switch six energization patterns for energizing the three-phase coils by use of the motor drive unit in a predetermined order according to a variation of the phase of the position signal. During an activation period of the motor, the control circuit unit performs activation control so that an energization time of one or more particular energization patterns corresponding to a rotational direction of the motor is shorter than an energization time of each of the other energization patterns.

### CROSS REFERENCE TO RELATED APPLICATIONS

This application claims the benefit of Japanese Patent Application No. 2017-142084, filed on Jul. 21, 2017, which is hereby incorporated by reference in its entirety.

### BACKGROUND

### Technical Field

The present disclosure relates to a motor drive control device and a motor drive control method, and more particularly to a motor drive control device and a motor drive control method capable of performing so-called single-sensor drive.

### Background

A device for driving a motor by so-called single-sensor drive is known as a motor drive control device for driving a motor. For example, a device for driving a motor by using only one hall sensor for detecting a magnetic pole position of the motor is known.

When the motor is driven by the single-sensor driving, it is impossible to specify the magnetic pole position unlike a case where plural sensors are used.

The configuration of a fan motor driving control device using only one magnetic pole position detecting sensor for a rotor is described in Patent Document 1 (JP2004-140962A). This fan motor driving control device performs braking control for positioning a rotor at a predetermined position by performing PWM energization on one switching element on one side of a positive voltage side and a negative voltage side of an inverter circuit and two switching elements on the other side of the positive and negative voltage sides based on an output signal of a magnetic pole position detecting sensor before a brushless motor is activated.

With single-sensor drive, a problem might occur when an external load is applied to a rotary shaft of the motor and an abnormal condition (in the abnormal condition the motor is rotated in reverse) has occurred before the driving of the motor.

A specific example will be described. In the fan motor, a load is applied to the fan resulting in the fan rotating in reverse, and the fan motor may be forcibly rotated in reverse. For example, the un-driven fan motor may be forcibly rotated in a direction opposite to a rotation instructing direction due to a strong external wind, depending on the use environment. In a device provided with a plurality of fan motors, the difference in air pressure between the inside and the outside of the device becomes great due to the influence of the other fan motor during driving, and the un-driven fan motor may be forcibly rotated in reverse. When the motor thus rotating in reverse is activated, it is impossible to rotate the rotary shaft in a positive direction at the torque during activation, and the fan motor may be forcibly and continuously rotated in reverse.

When an abnormal condition (in the abnormal condition the motor is rotated in reverse) has occurred, it is preferable to detect such abnormal condition and stop the activation of the motor. However, a single-sensor drive system may not detect the abnormal condition (in the abnormal condition the motor is rotated in reverse).

The present disclosure is related to providing a motor drive control device and a motor drive control method capable of activating a motor in a particular direction rapidly and reliably even when an abnormal condition (in the abnormal condition the motor is rotated in reverse) has occurred.

### SUMMARY

According to the first aspect of the present disclosure, a motor drive control device includes a motor drive unit configured to selectively energize three-phase coils of a motor, one position detector configured to output a position signal for varying a phase corresponding to a position of a rotor of the motor, and a control circuit unit configured to output a drive control signal to the motor drive unit to switch six energization patterns for energizing the three-phase coils by use of the motor drive unit in a predetermined order according to a variation of the phase of the position signal, wherein during an activation period of the motor, the control circuit unit performs activation control so that an energization time of one or more particular energization patterns corresponding to a rotational direction of the motor is shorter than an energization time of each of the other energization patterns.

Preferably, every time a predetermined reference timing corresponding to a variation of the phase of the position signal arrives, the control circuit unit switches the energization pattern a plurality of times with reference to the timing, and the particular energization patterns include an energization pattern switched subsequent to an energization pattern when the reference timing arrives.

Preferably, the energization time of each of the particular energization patterns when the activation control is performed is a time set in advance.

Preferably, the control circuit unit includes an accelerating condition determination unit configured to determine, based on the position signal, whether a rotation of the motor is in a predetermined accelerating condition when the activation control is performed, and after the accelerating condition determination unit determines that the rotation of the motor is in the predetermined accelerating condition, the control circuit unit reduces a ratio of the energization time of each of the particular energization patterns to the energization time of each of the other energization patterns compared to the ratio obtained when the activation control is performed.

Preferably, the accelerating condition determination unit measures a time corresponding to a period of the position signal to determine whether the rotation of the motor is more accelerated than the rotation previously measured, increases a determination value when determining that the rotation of the motor is accelerated, decreases the determination value when determining that the rotation of the motor is not accelerated, and determines whether the rotation of the motor is in a predetermined accelerating condition based on a result of comparison between the determination value and a predetermined acceleration determination threshold.

Preferably, the control circuit unit includes an energization switching signal output unit configured to output an energization switching signal corresponding to the timing when the energization pattern is switched based on the position signal, a motor control unit configured to output the drive control signal to the motor drive unit based on the energization switching signal to switch the energization pattern, and an acceleration determination unit configured to determine, based on the energization switching signal, whether the rotation of the motor is in the predetermined accelerating condition and outputs an acceleration determination signal based on the determined result, wherein the motor control unit performs a normal operation of the motor when the acceleration determination signal corresponding to the determined result indicating the predetermined accelerating condition is output when the activation control is performed.

According to the second aspect of the present disclosure, a method of driving a motor using a motor drive control device including a motor drive unit configured to selectively energize three-phase coils of the motor and one position detector configured to output a position signal for varying a phase corresponding to a position of a rotor of the motor, to switch six energization patterns for energizing the three-phase coils by use of the motor drive unit in a predetermined order according to a variation of the phase of the position signal, the method comprising performing, during an activation period of the motor, activation control so that an energization time of one or more particular energization patterns corresponding to a rotational direction of the motor is shorter than an energization time of each of the other energization patterns, and after the activation control is performed, reducing a ratio of the energization time of each of the particular energization patterns to the energization time of each of the other energization patterns compared to the ratio obtained when the activation control is performed.

According to these disclosures, it is possible to provide a motor drive control device and a motor drive control method capable of activating a motor in a particular direction rapidly and reliably even when an abnormal condition (in the abnormal condition the motor is rotated in reverse) has occurred.

### BRIEF DESCRIPTION OF THE DRAWINGS

FIG. 1 is a diagram illustrating a configuration of a motor drive control device according to one embodiment of the present disclosure.

FIG. 2 is a diagram for illustrating the switching of the energization patterns when a synchronous motor is rotated in the first rotational direction.

FIG. 3 is a diagram for illustrating the switching of the energization patterns when the synchronous motor is rotated in the second rotational direction.

FIG. 4 is a flowchart illustrating a basic operation of the motor drive control device.

FIG. 5 is a diagram for illustrating activation control when the synchronous motor is rotated in the first rotational direction.

FIG. 6 is a diagram for illustrating activation control when the synchronous motor is rotated in the second rotational direction.

FIG. 7 is a flowchart illustrating an operation of a control circuit unit when the activation control is performed.

FIG. 8 is a flowchart illustrating an operation of an acceleration determination process.

FIG. 9 is a diagram for illustrating the first operation example of the motor drive control device when the synchronous motor starts to be driven.

FIG. 10 is a diagram for illustrating the second operation example of the motor drive control device when the synchronous motor starts to be driven.

FIG. 11 is the first diagram for describing the activation control in a variation of the present embodiment.

FIG. 12 is the second diagram for describing the activation control in a variation of the present embodiment.

### DETAILED DESCRIPTION

Hereinafter, a motor drive control device according to embodiments of the present disclosure will be described.

### Embodiments

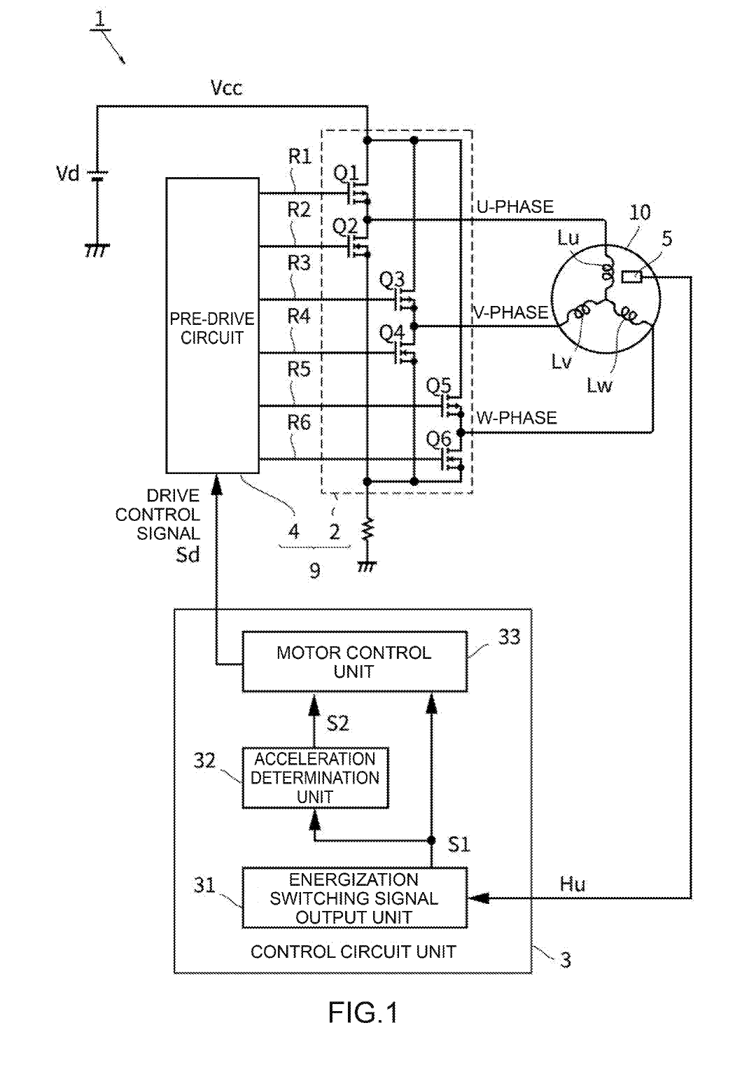

FIG. 1 is a block diagram illustrating a configuration of a motor drive control device 1 according to one embodiment of the present disclosure.

As illustrated in FIG. 1, the motor drive control device 1 includes a control circuit unit 3, a position detector 5, and a motor drive unit 9. The motor drive control device 1 supplies drive power to a synchronous motor (an example of a motor) 10 to drive the synchronous motor 10. Note that the synchronous motor 10 in the present embodiment is a three-phase motor having coils Lu, Lv and Lw of the U-phase, the V-phase and the W-phase.

The position detector 5 corresponds to any one of a plurality of phases of the synchronous motor 10, and outputs a position signal Hu for varying the phase, corresponding to a position of the rotor of the synchronous motor 10. Specifically, the position detector 5 is, for example, a magnetic sensor such as a hall element or a hall IC, and the position signal Hu is a hall signal. The position signal Hu output from the position detector 5 is input to the control circuit unit 3. The position detector 5 detects a position of the rotor at one position in the synchronous motor 10, and outputs the position signal Hu. For example, one position detector 5 is provided for the U-phase coil Lu.

During one rotation of the rotor, the position signal Hu is changed from low to high (rising: rising edge) when the rotor passes through a predetermined position (when the rotor is at the first rotational position), and the position signal Hu is returned from high to low (falling: falling edge) when the rotor passes through another predetermined position (when the rotor is at the second rotational position). The position signal Hu is periodically switched between high and low according to the rotation of the rotor. The position detector 5 corresponds to any one of the U-phase, the V-phase, and the W-phase of the synchronous motor 10. That is, each of the first rotational position and the second rotational position is a position corresponding to any one phase of the synchronous motor 10. The position signal Hu is a signal whose phase varies according to the position of the rotor, that is, according to the positional relationship between any one phase and the rotor of the synchronous motor 10. Note that as the position signal Hu, a signal periodically alternating between high and low may be directly output from the position detector 5 or an analog position signal Hu output from the position detector 5 may be converted to the signal periodically alternating between high and low after being input to the control circuit unit 3 (in the following description, such a signal converted from the analog position signal Hu is also referred to as a position signal Hu).

In the present embodiment, only one position detector 5 is provided. That is, the position signal Hu detected at only one position in the synchronous motor 10 is input to the control circuit unit 3. Note that a plurality of position detectors 5 may be provided to correspond to a plurality of phases, respectively, so that the position signal Hu output from only one of the plurality of position detectors 5 is input to the control circuit unit 3 and used. That is, in the present embodiment, the position signal Hu output from one position detector 5 is input to the control circuit unit 3. The motor drive control device 1 adopts a single-sensor system of using only one position detector 5 for detecting the position of the rotor, and drives the synchronous motor 10.

The motor drive unit 9 selectively energizes the coils Lu, Lv and Lw of a plurality of phases of the synchronous motor 10. The motor drive unit 9 includes an inverter circuit 2 and a pre-drive circuit 4. A drive control signal Sd output from the control circuit unit 3 is input to the motor drive unit 9.

The inverter circuit 2 selectively energizes three-phase coils Lu, Lv and Lw of the synchronous motor 10 based on six types of drive signals R1 to R6 output from the pre-drive circuit 4 to control the rotation of the synchronous motor 10.

In the present embodiment, the inverter circuit 2 has six switching elements Q1 to Q6 for supplying driving current to the respective coils Lu, Lv and Lw of the synchronous motor 10. The switching elements Q1, Q3 and Q5 are high-side switching elements each comprising MOSFET (Metal-Oxide-Semiconductor Field Effect Transistor) of P-channel arranged on the positive electrode side of a DC power source Vcc. The switching elements Q2, Q4 and Q6 are low-side switching elements each comprising MOSFET of N-channel arranged on the negative electrode side of the DC power source Vcc. The two switching elements Q1 and Q2 are connected to each other in series and the same is true of the combination of the switching elements Q3 and Q4 and the combination of the switching elements Q5 and Q6. These three pairs of series circuits are connected to one another in parallel to configure a bridge circuit. The connection point between the switching elements Q1 and Q2 is connected to the coil Lu of U-phase, the connection point between the switching elements Q3 and Q4 is connected to the coil Lv of V-phase, and the connection point between the switching elements Q5 and Q6 is connected to the coil Lw of W-phase.

The pre-drive circuit 4 has a plurality of output terminals to be connected to the respective gate terminals of the six switching elements Q1 to Q6 in the inverter circuit 2. The drive signals R1 to R6 are output from the respective output terminals to control ON/OFF operation of the switching elements Q1 to Q6. The drive control signal Sd output from the control circuit unit 3 is input to the pre-drive circuit 4. The pre-drive circuit 4 outputs the drive signals R1 to R6 based on the drive control signal Sd to operate the inverter circuit 2. That is, the inverter circuit 2 selectively energizes the coils Lu, Lv and Lw of the respective phases of the synchronous motor 10 based on the drive control signal Sd.

The control circuit unit 3 is formed by a microcomputer, a digital circuit, and the like, for example. The control circuit unit 3 may be formed with a programmable device such as a DSP (Digital Signal Processor), an FPGA (Field Programmable Gate Array), a microcomputer, and the like, for example, but is not limited to the examples.

The control circuit unit 3 outputs the drive control signal Sd for driving the synchronous motor 10 to the motor drive unit 9 to control the synchronous motor 10. The control circuit unit 3 outputs the drive control signal Sd for operating the plurality of switching elements Q1 to Q6 to the motor drive unit 9, and controls the synchronous motor 10, thereby rotating the synchronous motor 10. The control circuit unit 3 outputs the drive control signal Sd to the pre-drive circuit 4 based on the position signal Hu output from the position detector 5.

The control circuit unit 3 switches six energization patterns for energizing the three-phase coils Lu, Lv and Lw by use of the motor drive unit 9 in a predetermined order according to the variation of the phase of the position signal Hu.

That is, the synchronous motor 10 has the three-phase coils Lu, Lv and Lw, resulting in provision of six energization patterns. That is, the six energization patterns include (1) the first energization pattern comprising a combination of a high-side U-phase UH and a low-side V-phase VL, (2) the second energization pattern comprising a combination of the high-side U-phase UH and a low-side W-phase WL, (3) the third energization pattern comprising a combination of a high-side V-phase VH and the low-side W-phase WL, (4) the fourth energization pattern comprising a combination of a high-side V-phase VH and a low-side U-phase UL, (5) the fifth energization pattern comprising a combination of a high-side W-phase WH and the low-side U-phase UL, and (6) the sixth energization pattern comprising a combination of the high-side W-phase WH and the low-side V-phase VL.

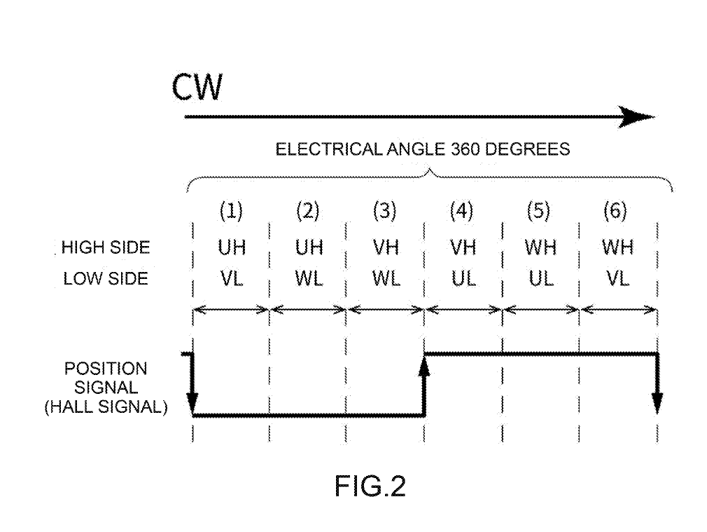

FIG. 2 is a diagram for illustrating the switching of the energization patterns when the synchronous motor 10 is rotated in the first rotational direction.

FIG. 2 illustrates a transition of the energization patterns for one cycle (360 degrees) of the electrical angle. FIG. 2 illustrates an arrow indicating a switching direction of the energization patterns, coils to be energized and a waveform example of the position signal Hu in this order from the top.

As illustrated in FIG. 2, when the synchronous motor 10 is rotated in the first rotational direction CW, the control circuit unit 3 repeatedly performs one cycle of switching control for switching all of the six energization patterns in a predetermined order. The predetermined order is an order of the first energization pattern (1), the second energization pattern (2), the third energization pattern (3), the fourth energization pattern (4), the fifth energization pattern (5) and the sixth energization pattern (6), for example.

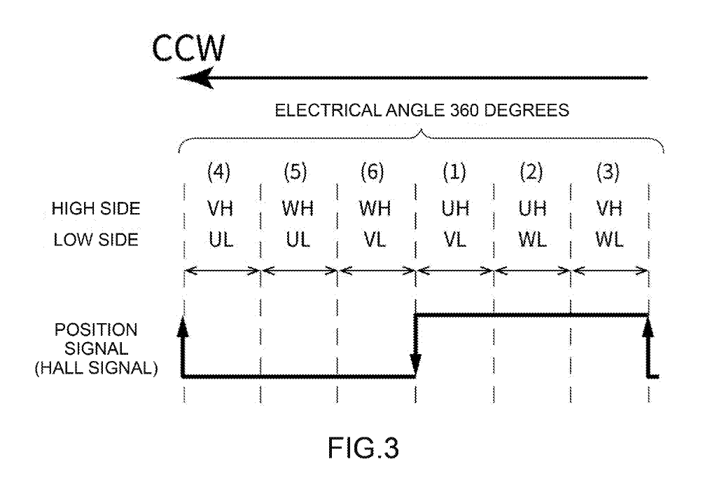

FIG. 3 is a diagram for illustrating the switching of the energization patterns when the synchronous motor 10 is rotated in the second rotational direction.

FIG. 3 illustrates a transition of the energization patterns for one cycle (360 degrees) of the electrical angle. FIG. 3 illustrates an arrow indicating a switching direction of the energization patterns, coils to be energized and a waveform example of the position signal Hu in this order from the top.

When the synchronous motor 10 is rotated in the second rotational direction CCW in a direction opposite to the first rotational direction CW, the control circuit unit 3 repeatedly performs one cycle of switching control for switching all of the six energization patterns in a predetermined direction. An order when the synchronous motor 10 is rotated in the second rotational direction CCW is an order in the direction opposite to the predetermined direction. For example, the order is an order of the third energization pattern (3), the second energization pattern (2), the first energization pattern (1), the sixth energization pattern (6), the fifth energization pattern (5) and the fourth energization pattern (4).

In the present embodiment, every time a predetermined reference timing corresponding to a variation of a phase of the position signal Hu arrives, the control circuit unit 3 switches the energization patterns a plurality of times with reference to the timing. The reference timing is, for example, a timing of the rising edge and a timing of the falling edge of the position signal Hu. The rising edge of the position signal Hu is indicated by an upward arrow for the position signal Hu in FIG. 2 and FIG. 3. The falling edge of the position signal Hu is indicated by a downward arrow for the position signal Hu in FIG. 2 and FIG. 3.

Specifically, when the rising edge of the position signal Hu arrives, with reference to this timing, the energization pattern is switched one time, and then the energization pattern is switched two times at a predetermined interval. When the falling edge of the position signal Hu arrives, with reference to this timing, the energization pattern is switched one time, and then the energization pattern is switched two times at a predetermined interval.

An energization pattern to be switched when the rising edge of the position signal Hu arrives and an energization pattern to be switched when the falling edge of the position signal Hu arrives are determined according to the rotational direction of the synchronous motor 10.

More specifically, as illustrated in FIG. 2, in case of rotating the synchronous motor 10 in the first rotational direction CW, the energization pattern is switched to the first energization pattern (1) when the falling edge of the position signal Hu arrives. Subsequently, during a half cycle of the electric angle with reference to the falling edge of the position signal Hu, the energization pattern is switched two times. That is, the energization pattern is switched to the second energization pattern (2) when a predetermined interval (time corresponding to the electrical angle of 60 degrees) has elapsed after the energization pattern was switched to the first energization pattern (1). Subsequently, when the predetermined interval has elapsed, the energization pattern is switched from the second energization pattern (2) to the third energization pattern (3). When the rising edge of the position signal Hu arrives, with reference to this timing, the energization pattern is switched from the third energization pattern (3) to the fourth energization pattern (4) based on the reference timing. Subsequently, the energization pattern is switched from the fourth energization pattern (4) to the fifth energization pattern (5), and then from the fifth energization pattern (5) to the sixth energization pattern (6) every time the predetermined interval elapses.

As illustrated in FIG. 3, to rotate the synchronous motor 10 in the second rotational direction CCW, the energization pattern is switched to the third energization pattern (3) when the rising edge of the position signal Hu arrives. Subsequently, every time the predetermined interval elapses, the energization pattern is switched from the third energization pattern (3) to the second energization pattern (2), and then from the second energization pattern (2) to the first energization pattern (1). When the falling edge of the position signal Hu arrives, with reference to this timing, the energization pattern is switched from the first energization pattern (1) to the sixth energization pattern (6). Subsequently, the energization pattern is switched from the sixth energization pattern (6) to the fifth energization pattern (5), and then from the fifth energization pattern (5) to the fourth energization pattern (4) every time the predetermined interval elapses.

In this way, each of the rising edge and the falling edge of the position signal Hu arrives one time during one cycle of the electrical angle of the synchronous motor 10, and with reference to the rising edge timing and the falling edge, the energization pattern is switched six times in total. During the normal operation of the synchronous motor 10, the energization pattern is switched according to the rotational speed of the synchronous motor 10 or the period (one period or half period) of the position signal Hu so that the energization time of each energization pattern becomes equal and the time corresponds to the electrical angle of 60 degrees.

Returning to FIG. 1, the control circuit unit 3 includes an energization switching signal output unit 31, an acceleration determination unit (an example of an accelerating condition determination unit) 32 and a motor control unit 33. Although the details will be described later, during an activation period of the synchronous motor 10, the control circuit unit 3 performs activation control so that the energization time of one or more particular energization patterns corresponding to the rotational direction of the synchronous motor 10 is shorter than the energization time of each of the other energization patterns. During the activation control performed by the control circuit unit 3, the acceleration determination unit 32 determines, based on the position signal Hu, whether the rotation of the synchronous motor 10 is in a predetermined accelerating condition. After the acceleration determination unit 32 determines that the rotation of the synchronous motor 10 is in the predetermined accelerating condition, the control circuit unit 3 reduces a ratio of the energization time of each of the particular energization patterns to the energization time of each of the other energization patterns compared to the ratio obtained when the activation control is performed.

The position signal Hu output from the position detector 5 is input to the energization switching signal output unit 31. The energization switching signal output unit 31 outputs an energization switching signal S1 corresponding to the timing when the energization pattern is switched based on the position signal Hu. For example, the energization switching signal output unit 31 detects the rising edge or the falling edge of the position signal Hu, and outputs the energization switching signal S1 to switch the energization pattern at the above-described timing. The energization switching signal S1 is output to the acceleration determination unit 32 and the motor control unit 33. Note that the energization switching signal S1 may be output at the timing when the rising edge or the falling edge of the position signal Hu arrives so that the motor control unit 33 switches the energization pattern a plurality of times according to the timing when the energization switching signal S1 is output.

The acceleration determination unit 32 determines, based on the energization switching signal S1, whether the rotation of the synchronous motor 10 is in the predetermined accelerating condition, and outputs an acceleration determination signal S2 based on the determined result. The acceleration determination signal S2 is output to the motor control unit 33. For example, the acceleration determination unit 32 determines the rotational speed of the synchronous motor 10 based on the timing when the rising edge or the falling edge of the position signal Hu arrives, and determines whether the synchronous motor 10 is in the predetermined accelerating condition. The predetermined accelerating condition will be described later.

The motor control unit 33 outputs the drive control signal Sd based on the energization switching signal S1 to switch the energization pattern. The motor control unit 33 generates the drive control signal Sd, and outputs the generated drive control signal Sd to the pre-drive circuit 4 in the motor drive unit 9.

The operation of the motor drive control device 1 will be described below.

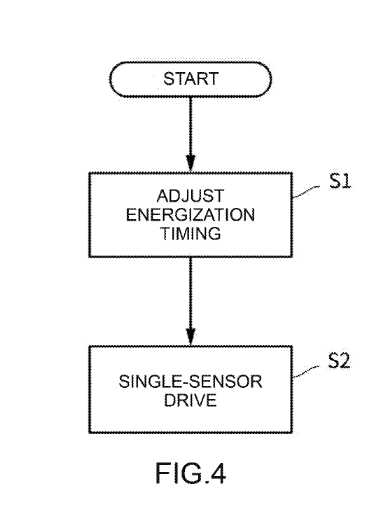

FIG. 4 is a flowchart illustrating a basic operation of the motor drive control device 1.

As illustrated in FIG. 4, the motor drive control device 1 adjusts the energization timing including the activation control (described later) during the activation period of the synchronous motor 10 (step S1), and then performs single-sensor drive to shift to the normal operation (step S2). Although the details will be described later, a drive control method for the synchronous motor 10 in the present embodiment using the motor drive control device 1 including the motor drive unit 9 configured to selectively energize the three-phase coils Lu, Lv and Lw of the synchronous motor 10 and one position detector 5 configured to output the position signal Hu for varying the phase corresponding to a position of the rotor of the synchronous motor 10 to switch the energization pattern for energizing the three-phase coils Lu, Lv and Lw by use of the motor drive unit 9 in a predetermined order according to the variation of the phase of the position signal Hu to drive the synchronous motor 10. The drive control method comprises performing, during the activation period of the synchronous motor 10, activation control so that the energization time of one or more particular energization patterns corresponding to the rotational direction of the synchronous motor 10 is shorter than the energization time of each of the other energization patterns, and reducing a ratio of the energization time of each of the particular energization patterns to the energization time of each of the other energization patterns compared to the ratio obtained when the activation control is performed, after the activation control is performed.

The motor drive control device 1 performs forced commutation of the synchronous motor 10 during the activation period of the synchronous motor 10. During the activation period of the synchronous motor 10, the motor drive control device 1 adjusts the energization timing (step S1). That is, the control circuit unit 3 adjusts the energization pattern based on the position signal Hu during the activation period of the synchronous motor 10 to match the variation timing of the phase of the position signal Hu and the energization pattern. That is, the control circuit unit 3 synchronizes the rotation of the rotor of the synchronous motor 10 and the energization timing of each energization pattern. The activation control is performed with the energization timing adjustment.

Subsequently, the motor drive control device 1 performs single-sensor drive (normal operation of the synchronous motor 10 by a single-sensor system) when the synchronous motor 10 is activated in the first step (step S2). That is, the control circuit unit 3 outputs the drive control signal Sd (starts the normal operation) according to the period of the position signal Hu. Thus, the control circuit unit 3 switches the energization pattern of the coils Lu, Lv and Lw energized by use of the motor drive unit 9 in a predetermined order corresponding to the rotational speed.

In the present embodiment, during the activation period of the synchronous motor 10, the control circuit unit 3 performs activation control so that the energization time of one or more particular energization patterns corresponding to the rotational direction of the synchronous motor 10 is shorter than the energization time of each of the other energization patterns.

In the normal operation, the particular energization patterns include an energization pattern switched subsequent to the energization pattern when the reference timing arrives. In other words, in the normal operation, the particular energization patterns include an energization pattern switched when the rising edge or the falling edge of the position signal Hu arrives. Specifically, for example, when the synchronous motor 10 is rotated in the first rotational direction CW, the particular energization patterns include the first energization pattern (1) switched when the falling edge of the position signal Hu arrives and the fourth energization pattern (4) switched when the rising edge of the position signal Hu arrives. When the synchronous motor 10 is rotated in the second rotational direction CCW, the particular energization patterns include the third energization pattern (3) switched when the rising edge of the position signal Hu arrives, and the sixth energization pattern (6) switched when the falling edge of the position signal Hu arrives.

More specifically, in the present embodiment, when the synchronous motor 10 is rotated in the first rotational direction CW, the particular energization patterns are the first energization pattern (1), the third energization pattern (3), the fourth energization pattern (4), and the sixth energization pattern (6), while the other energization patterns are fixed energization patterns such as the second energization pattern (2) and the fifth energization pattern (5). When the synchronous motor 10 is rotated in the second rotational direction CCW, the particular energization patterns are the first energization pattern (1), the sixth energization pattern (6), the fourth energization pattern (4), and the third energization pattern (3), while the other energization patterns are fixed energization patterns such as the second energization pattern (2) and the fifth energization pattern (5). The energization time of each of the particular energization patterns is a time set in advance. For example, the energization time of each of the particular energization patterns is set to be shorter (time close to zero). The energization time of each of the particular energization patterns may be set to be short to such an extent that the switching elements Q1 to Q6 are not turned on simultaneously in the energization patterns before and after switching. Therefore, when the activation control is performed, a total of the two fixed energization patterns other than the particular energization patterns are apparently switched according to the variation of the phase of the position signal Hu (such an energization mode during the activation control is sometimes referred to as two-pattern fixed energization).

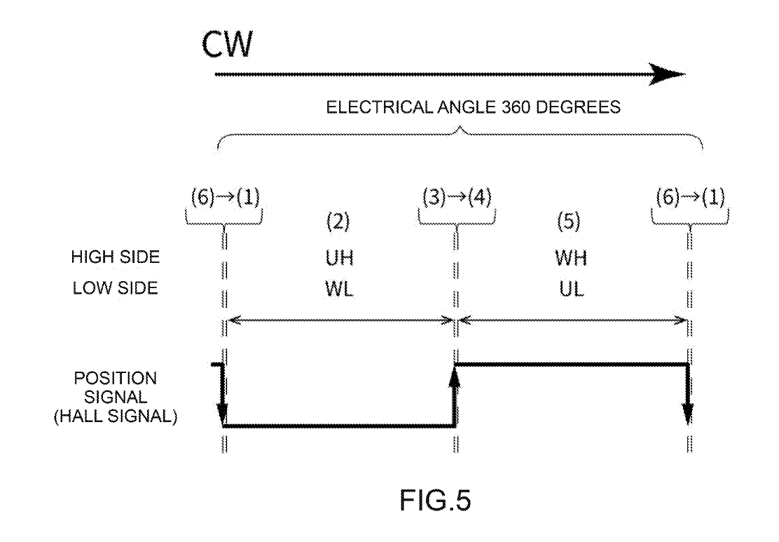

FIG. 5 is a diagram for illustrating activation control when the synchronous motor 10 is rotated in the first rotational direction.

Similar to FIG. 2, FIG. 5 illustrates a transition of the energization patterns for one cycle (360 degrees) of the electrical angle when the activation control is performed.

As illustrated in FIG. 5, in the activation control when the synchronous motor 10 is rotated in the first rotational direction CW, the energization time of each of the particular energization patterns such as the first energization pattern (1), the third energization pattern (3), the fourth energization pattern (4) and the sixth energization pattern (6) is shorter than that of each of the fixed energization patterns (the second energization pattern (2) and the fifth energization pattern (5)) other than the particular energization patterns. The motor control unit 33 switches the energization pattern when the rising edge or the falling edge of the position signal Hu arrives, and switches the particular energization pattern to a subsequent energization pattern in a shorter energization time. Thus, the second energization pattern (2) is continued until the rising edge of the position signal Hu arrives, is subsequently switched to the two particular energization patterns (the third energization pattern (3) and the fourth energization pattern (4)) when the rising edge of the position signal Hu arrives, and then is immediately switched to the fifth energization pattern (5). Then, the fifth energization pattern (5) is continued until the falling edge of the position signal Hu arrives, is subsequently switched to the two particular energization patterns (the sixth energization pattern (6) and the first energization pattern (1)) when the falling edge of the position signal Hu arrives, and then immediately switched to the second energization pattern (2).

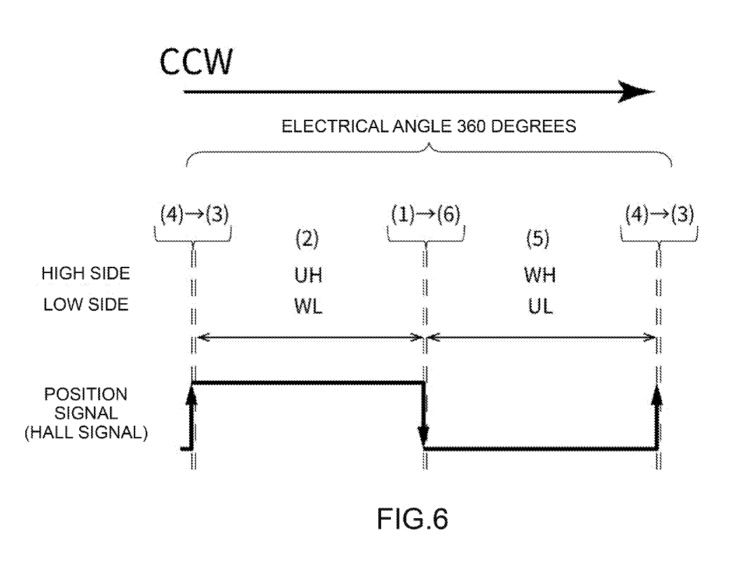

FIG. 6 is a diagram for illustrating activation control when the synchronous motor 10 is rotated in the second rotational direction.

Similar to FIG. 2, FIG. 6 illustrates a transition of the energization patterns for one cycle (360 degrees) of the electrical angle when the activation control is performed. In FIG. 6 the switching direction of the energization patterns is illustrated to be opposite to the switching direction in in FIG. 3.

As illustrated in FIG. 6, in the activation control when the synchronous motor 10 is rotated in the second rotational direction CCW in a direction opposite to the first rotational direction CW, the energization time of each of the particular energization patterns such as the first energization pattern (1), the sixth energization pattern (6), the fourth energization pattern (4) and the third energization pattern (3) is shorter than that of each of the fixed energization patterns (the second energization pattern (2) and the fifth energization pattern (5)) other than the particular energization patterns. When the synchronous motor 10 is rotated in the second rotational direction CCW, the fifth energization pattern (5) is continued until the rising edge of the position signal Hu arrives, is subsequently switched to the two particular energization patterns (the fourth energization pattern (4) and the third energization pattern (3)) when the rising edge of the position signal Hu arrives, and then is immediately switched to the second energization pattern (2). Then, the second energization pattern (2) is continued until the falling edge of the position signal Hu arrives, is subsequently switched to the two particular energization patterns (the first energization pattern (1) and the sixth energization pattern (6)) when the falling edge of the position signal Hu arrives, and then immediately switched to the fifth energization pattern (5).

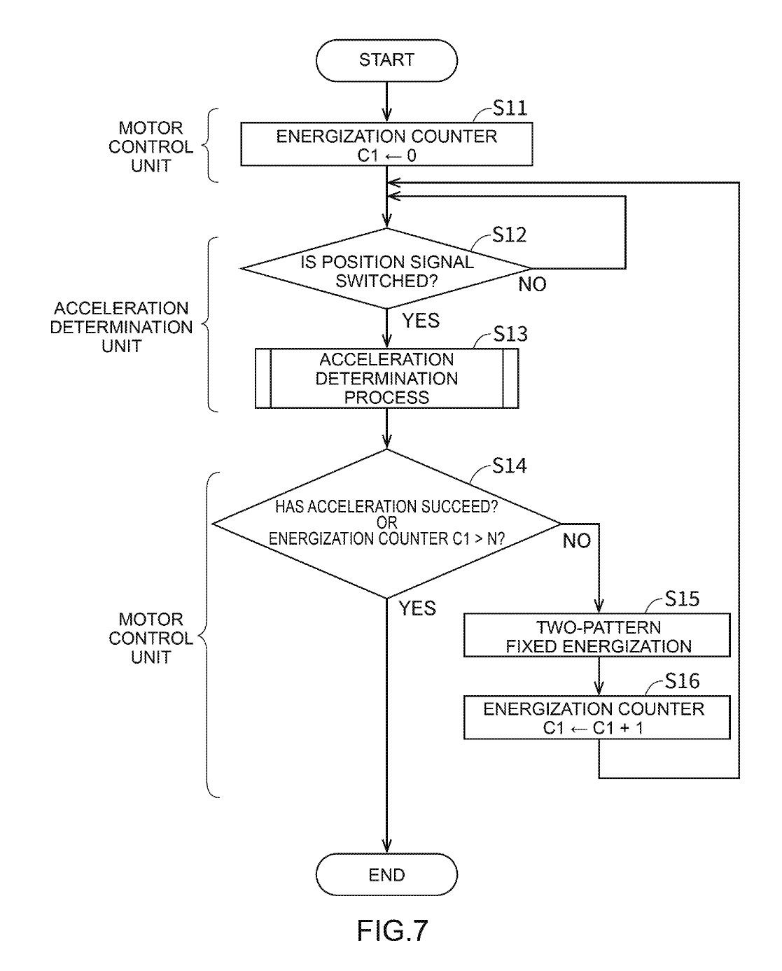

FIG. 7 is a flowchart illustrating an operation of the control circuit unit 3 when the activation control is performed.

As illustrated in FIG. 7, when the activation control is started, the motor control unit 33 resets an energization counter C1 to zero in step S11.

In step S12, the acceleration determination unit 32 determines whether the rising edge or the falling edge of the position signal Hu has been detected based on the energization switching signal S1. When the rising edge or the falling edge has been detected (that is, when the position signal Hu is switched from high to low), the process proceeds to step S13.

In step S13, the acceleration determination unit 32 performs an acceleration determination process.

In step S14, the motor control unit 33 determines whether the acceleration has succeeded in the acceleration determination process. The motor control unit 33 also determines whether the energization counter C1 is greater than a count threshold N. When the motor control unit 33 determines that the acceleration has succeeded, or the energization counter C1 is greater than the count threshold N (YES), the motor control unit 33 ends the process. Otherwise, the process proceeds to step S15 (NO).

In step S15, the motor control unit 33 performs the two-pattern fixed energization as described above.

In step S16, the motor control unit 33 adds 1 to the value of the energization counter C1. Subsequently, the process is returned to the process of step S12.

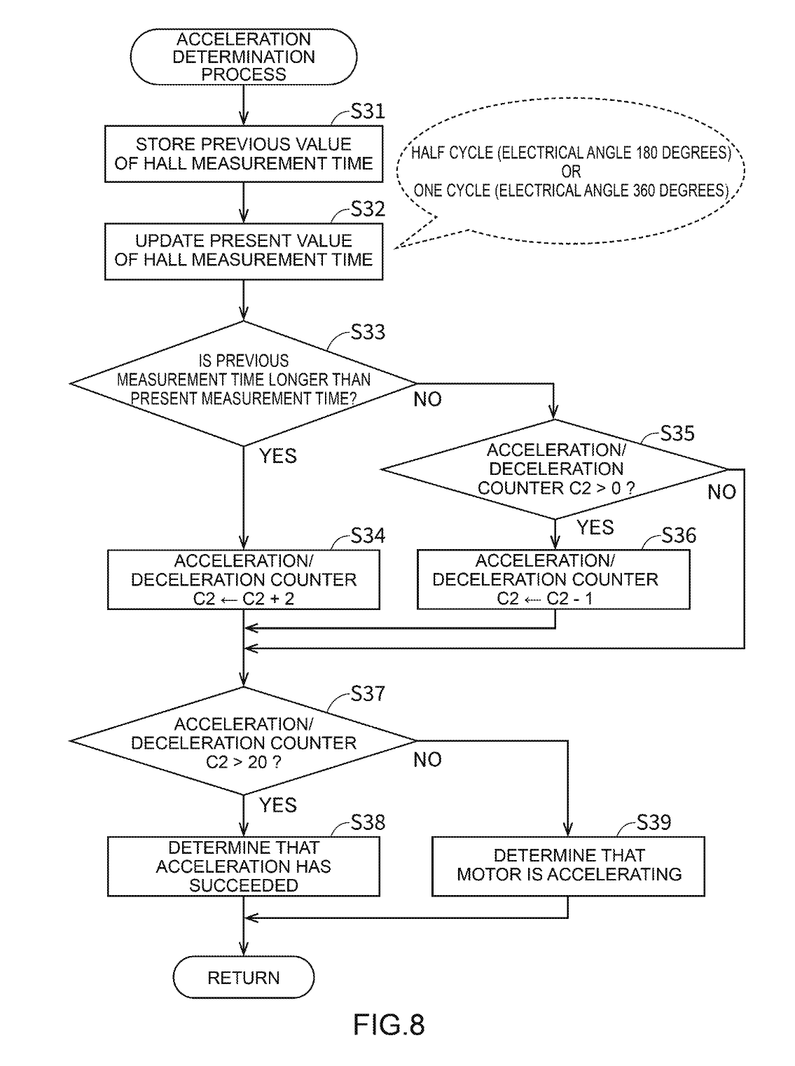

FIG. 8 is a flowchart illustrating an operation of the acceleration determination process. As described later, in the present embodiment, the acceleration determination unit 32 determines whether the rotation of the synchronous motor 10 is in a predetermined accelerating condition based on the energization switching signal S1 output by the energization switching signal output unit 31, and outputs the acceleration determination signal S2 based on the determined result. In the case where the activation control is performed, the motor control unit 33 performs the normal operation of the synchronous motor 10 when the acceleration determination signal S2 corresponding to the determined result indicating that the rotation of the synchronous motor 10 is in the predetermined accelerating condition is output from the acceleration determination unit 32.

The acceleration determination unit 32 measures the time (hall measurement time) corresponding to the period of the position signal Hu, to determine whether the rotation of the synchronous motor 10 is more accelerated than the rotation previously measured. The acceleration determination unit 32 increases the value of an acceleration/deceleration counter C2 taken as a determination value when determining that the rotation of the synchronous motor 10 is accelerated, while decreasing the value of the acceleration/deceleration counter C2 taken as a determination value when determining that the rotation of the synchronous motor 10 is not accelerated. The acceleration determination unit 32 determines whether the rotation of the synchronous motor 10 is in the accelerating condition based on a result of comparison between the value of the acceleration/deceleration counter C2 taken as a determination value and a predetermined acceleration determination threshold. When the rotation of the synchronous motor 10 is in the predetermined accelerating condition, the acceleration determination unit 32 determines that the acceleration has succeeded.

Specifically, in step S31, the acceleration determination unit 32 stores the hall measurement time measured when the previous acceleration determination process was performed as a previous value.

In step S32, the acceleration determination unit 32 measures the present hall measurement time, and updates the present hall measurement time as the present value.

Note that, in the present embodiment, the hall measurement time is a time corresponding to a half period of the position signal Hu (an example of the time corresponding to the period of the position signal Hu). The hall measurement time can be measured by counting the time from the timing when the rising edge has previously arrived to the timing when the falling edge has arrived this time, and the time from the timing when the falling edge has previously arrived to the timing when the rising edge has arrived this time. The hall measurement time may be a time of one period of the position signal Hu (for electrical angle 360 degrees).

In step S33, the acceleration determination unit 32 determines whether the previous measurement time is longer than the present measurement time. That is, the acceleration determination unit 32 compares the previous value stored in step S31 with the present value updated in step S32, to determine whether the previous value is greater than the present value. In other words, the acceleration determination unit 32 measures the hall measurement time to determine whether the rotation of the synchronous motor 10 is more accelerated than the rotation previously measured. When the previous value is greater than the present value (YES), the result shows that the rotation of the synchronous motor 10 is accelerated. When the previous value is greater than the present value (YES), the process proceeds to step S34. Otherwise (NO), the process proceeds to step S35.

In step S34, the acceleration determination unit 32 increases the value of the acceleration/deceleration counter C2. For example, the acceleration determination unit 32 adds 2 to the value of the acceleration/deceleration counter C2.

On the other hand, in step S35, the acceleration determination unit 32 determines whether the value of the acceleration/deceleration counter C2 is greater than zero. When the value of the acceleration/deceleration counter C2 is greater than zero (YES), the process proceeds to step S36 to decrease the value of the acceleration/deceleration counter C2. For example, the acceleration determination unit 32 subtracts 1 from the value of the acceleration/deceleration counter C2.

Note that the value “2” added in step S34 and the value “1” subtracted in step S36 are evaluation values for determining whether the rotation of the synchronous motor 10 is in the predetermined accelerating condition. The evaluation value “2” added to the acceleration/deceleration counter C2 when the acceleration determination unit 32 determines that the rotation of the synchronous motor 10 is accelerated is more heavily weighted than the evaluation value “1” subtracted from the acceleration/deceleration counter C2 otherwise. Note that the evaluation value added and the evaluation value subtracted may be different from the value “2” and the value “1,” respectively.

The acceleration/deceleration counter C2 does not take a negative value. Thus, when the synchronous motor 10 is rotated in a direction opposite to the rotational direction and the activation control is started, the value of the acceleration/deceleration counter C2 is prevented from taking a negative value until the synchronous motor 10 then starts rotating in the rotational direction. Therefore, when the rotation of the synchronous motor 10 transitions to the predetermined accelerating condition, the acceleration determination unit 32 determines rapidly that the acceleration has succeeded.

In step S37, the acceleration determination unit 32 determines whether the value of the acceleration/deceleration counter C2 is greater than the predetermined acceleration determination threshold. The acceleration determination threshold is, for example, 20, but not limited to 20. When the acceleration/deceleration counter C2 is greater than 20 in step S37 (YES), the process proceeds to step S38. Otherwise, the process proceeds to step S39.

In step S38, the acceleration determination unit 32 determines that the acceleration has succeeded. That is, the control circuit unit 3 determines that the rotation of the synchronous motor 10 is in the predetermined accelerating condition. Thus, the acceleration determination unit 32 outputs the acceleration determination signal S2 indicating that the acceleration has succeeded. As a specific example, when the determination is made that the rotation of the synchronous motor 10 is accelerated for 10 consecutive times or that the rotation of the synchronous motor 10 is accelerated for 12 times with two subtractions of the acceleration/deceleration counter C2, the value of the acceleration/deceleration counter C2 exceeds 20, as a result, the acceleration determination unit 32 determines that the acceleration has succeeded.

In step S39, the acceleration determination unit 32 does not determine that the acceleration has succeeded, but determines that the synchronous motor 10 is accelerating. Thus, the acceleration determination unit 32 does not output the acceleration determination signal S2 indicating that the acceleration has succeeded.

When the process of step S38 or step S39 is performed, the acceleration determination process is ended.

Thus, when the acceleration determination process is performed, and the acceleration determination unit 32 determines that the acceleration has succeeded, the activation control is ended (YES in step S14 in FIG. 7). When the acceleration determination signal S2 corresponding to the determined result indicating that the rotation of the synchronous motor 10 is in the predetermined accelerating condition is output from the acceleration determination unit 32 in the case where the activation control is performed, the motor control unit 33 performs the normal operation of the synchronous motor 10. As described above, during the normal operation of the synchronous motor 10, the energization pattern is switched according to the rotational speed of the synchronous motor 10 or the period (one period or half period) of the position signal Hu so that the energization time of each energization pattern becomes substantially equal and the time corresponds to the electrical angle of 60 degrees. That is, after the acceleration determination unit 32 determines, in the accelerating condition determination process, that the rotation of the synchronous motor 10 is in the predetermined accelerating condition, the motor control unit 33 reduces a ratio of the energization time of each of the particular energization patterns to the energization time of each of the other energization patterns compared to the ratio obtained when the activation control is performed.

Note that, when the activation control is performed, the energization counter C1 is incremented in every half cycle of the electrical angle (every time the rising edge or the falling edge of the position signal Hu arrives) until a determination of YES is made in step S14 in FIG. 7. When the energization counter C1 exceeds the count threshold N due to external force, etc. before the acceleration determination unit 32 determines that the acceleration has succeeded, the acceleration determination unit 32 determines that the acceleration has failed, and the activation control is ended. When the synchronous motor 10 cannot be normally activated, the control circuit unit 3 can stop the driving of the synchronous motor 10 without shifting to the normal operation.

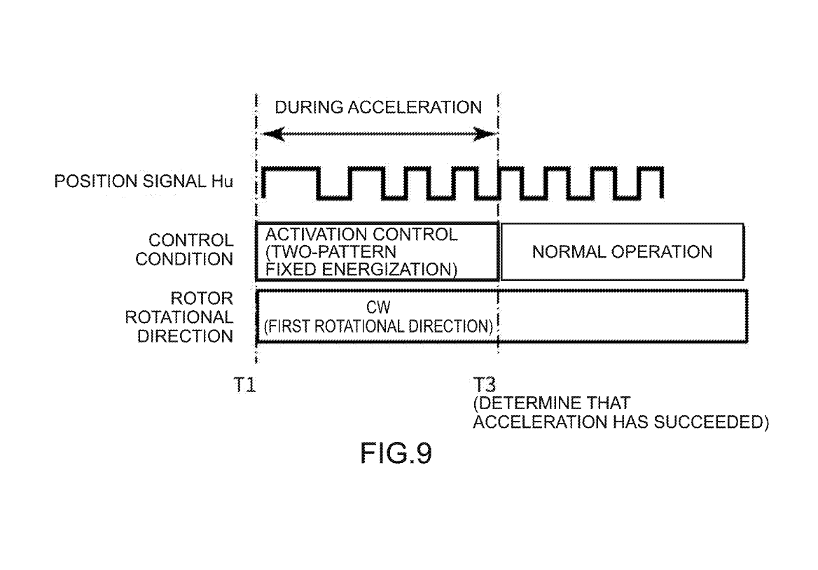

FIG. 9 is a diagram for illustrating the first operation example of the motor drive control device 1 when the synchronous motor 10 starts to be driven.

FIG. 9 illustrates a waveform of the position signal Hu, a control condition (distinction between activation control and normal operation) and a rotational direction of the rotor of the synchronous motor 10 from the top. FIG. 9 schematically illustrates the waveform of the position signal Hu and the number of the rising edges or the falling edges does not match the description in the above-described activation control.

FIG. 9 illustrates the case where the synchronous motor 10 is started up to rotate in the first rotational direction CW as an example, when the rotor of the synchronous motor 10 is rotated very little, for example. That is, as illustrated in FIG. 9, when the activation of the synchronous motor 10 is started at time T1, the rotor starts rotating in the first rotational direction CW. Therefore, the two-pattern fixed energization is performed by the activation control, thereby gradually accelerating the rotation of the synchronous motor 10 and gradually shortening the period of the position signal Hu. The acceleration determination process is performed by the acceleration determination unit 32 every time the rising edge or the falling edge of the position signal Hu arrives. When the acceleration determination unit 32 determines that the acceleration has succeeded at time T3, the activation control is ended, and the normal operation of the synchronous motor 10 is started. In this way, the synchronous motor 10 can be activated rapidly.

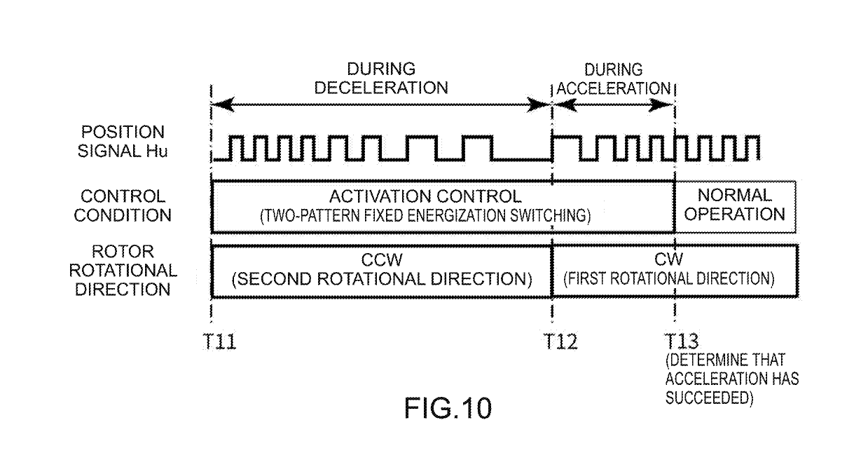

FIG. 10 is a diagram for illustrating the second operation example of the motor drive control device 1 when the synchronous motor 10 starts to be driven.

Similar to FIG. 9, FIG. 10 also illustrates a schematic waveform of the position signal Hu, a control condition (distinction between activation control and normal operation) and a rotational direction of the rotor of the synchronous motor 10 from the top.

FIG. 10 illustrates the case where the synchronous motor 10 is started up to rotate in the first rotational direction CW as an example, when the rotor of the synchronous motor 10 is rotated in the second rotational direction CCW. For example, assuming that the synchronous motor 10 used for rotating a fan is driven, when the fan rotates in reverse under external wind and the synchronous motor 10 is rotated in the second rotational direction CCW. Irrespective of the rotational direction of the synchronous motor 10, the phase of the position signal Hu varies at periods corresponding to the rotational speed of the rotor.

In such cases, as illustrated in FIG. 10, when the synchronous motor 10 is started up at time T11, the two-pattern fixed energization is performed by the activation control. In this way, the energization is performed in a direction of decelerating the rotation of the synchronous motor 10 in the second rotational direction CCW. Subsequently, the rotation of the synchronous motor 10 is gradually decelerated, and the period of the position signal Hu is gradually lengthened. At this time, the value of the acceleration/deceleration counter C2 is maintained at zero. Subsequently, when the rotational speed of the synchronous motor 10 becomes zero at time T12, the two-pattern fixed energization is continued, the synchronous motor 10 starts rotating in the first rotational direction CW, and the rotation in the first rotational direction CW is accelerated. Subsequently, the value of the acceleration/deceleration counter C2 is increased every time the acceleration determination unit 32 performs the acceleration determination process. When the acceleration determination unit 32 determines, at time T13, that the acceleration has succeeded, the activation control is ended, and the normal operation of the synchronous motor 10 is started. In this way, even when the synchronous motor 10 is rotated in a direction opposite to a direction of rotating the synchronous motor 10, the synchronous motor 10 can be activated rapidly.

For example, in the case where the external force applied to the synchronous motor 10 is strong, when the value of the acceleration/deceleration counter C2 does not exceed the acceleration determination threshold but the energization counter C1 exceeds the count threshold N, the acceleration determination unit 32 determines that the acceleration has failed, and the activation control is ended. When the synchronous motor 10 cannot be normally activated, the control circuit unit 3 can stop the driving of the synchronous motor 10 without shifting to the normal operation.

As described above, in the present embodiment, the synchronous motor 10 can be properly activated without using any special circuitry and without locking the rotor. Even when the synchronous motor 10 is in the reverse rotation condition during the activation period, especially after the reference timing corresponding to the variation of the phase of the position signal Hu, the torque applied in the reverse direction is not generated in the synchronous motor 10, thereby rendering it capable of performing the positive rotational drive reliably.

The synchronous motor 10 can be activated in the predetermined rotational direction, independent of in which direction it is rotated during the activation period. Accordingly, it is not necessary to determine whether the synchronous motor 10 is rotated in the first rotational direction CW or in the second rotational direction CCW. Therefore, the control circuit having a simple configuration can be adopted, thereby making it possible to reduce the manufacturing cost of the motor drive control device 1.

The energization time of each of the particular energization patterns is set to be shorter. In the activation control, the torque applied in the reverse direction is not generated in the synchronous motor 10, thereby rendering it capable of activating the synchronous motor 10 rapidly. The energization pattern is switched in the predetermined order through the energization of the particular energization patterns without eliminating the particular energization patterns, thereby rendering it capable of preventing noise from being generated from the motor drive control device 1.

The addition/subtraction of the acceleration/deceleration counter C2 is performed at the timing corresponding to the period of the position signal Hu. Based on the position signal Hu, a determination is made as to the abnormal condition and in the abnormal condition the synchronous motor 10 is rotated in reverse. Even when the acceleration is prevented due to a temporal external force, etc. applied to the synchronous motor 10 when the activation control is performed, for example, the immediate determination is not made that the acceleration has failed. Since the added value of the acceleration/deceleration counter C2 is weighted as described above, the determination is made that the acceleration has succeeded when the acceleration of the synchronous motor 10 is prevented due to external force, etc., but the synchronous motor 10 can be driven, thereby rendering it capable of activating the synchronous motor 10.

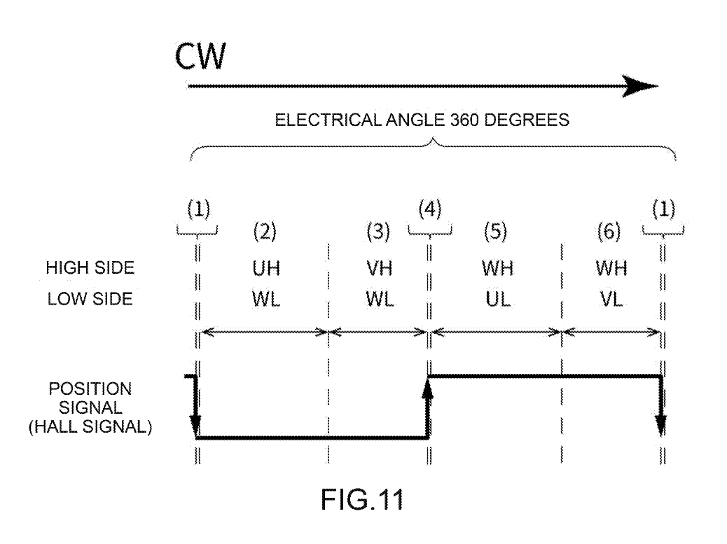

FIG. 11 is the first diagram for describing the activation control in a variation of the present embodiment.

FIG. 11 illustrates an example of activation control when the synchronous motor 10 is rotated in the first rotational direction in the same manner as illustrated in FIG. 5.

As illustrated in FIG. 11, according to the present variation, in the activation control when the synchronous motor 10 is rotated in the first rotational direction CW, the particular energization patterns, in the normal operation include the first energization pattern (1) switched when the falling edge of the position signal Hu has arrived, and the fourth energization pattern (4) switched when the rising edge has arrived. The four energization patterns other than the two particular energization patterns are fixed energization patterns. As with the above embodiment, the energization time of each of the particular energization patterns is set to be shorter (time close to zero) in advance. Therefore, when the activation control is performed, a total of the four fixed energization patterns other than the particular energization patterns are apparently switched according to the variation of the phase of the position signal Hu.

In the present variation, when the activation control is performed, the energization time of each of the particular energization patterns such as the first energization pattern (1) and the fourth energization pattern (4) is shorter than the energization time of each of the fixed energization patterns other than the particular energization patterns. The motor control unit 33 switches the particular energization pattern to a subsequent energization pattern in a shorter energization time when the rising edge or the falling edge of the position signal Hu has arrived. Therefore, when the falling edge of the position signal Hu arrives, the energization pattern is switched to the first energization pattern (1), and then immediately switched to the second energization pattern (2). After the lapse of a certain time, the energization time is switched to the third energization pattern (3), and the third energization pattern (3) is continued until the rising edge of the position signal Hu arrives. When the rising edge of the position signal Hu arrives, the energization pattern is switched to the fourth energization pattern (4), and then immediately switched to the fifth energization pattern (5). Subsequently, after the lapse of a certain time, the energization time is switched to the sixth energization pattern (6), and the sixth energization pattern (6) is continued until the falling edge of the position signal Hu arrives.

Note that, in the present variation, the time from when the energization pattern is switched to the second energization pattern (2) to when the energization pattern is switched to the third energization pattern (3), and the time from when the energization pattern is switched to the fifth energization pattern (5) to when the energization pattern is switched to the sixth energization pattern (6) may be set in advance, or may be set based on the previous period of the position signal Hu.

In the present variation, the similar effect to the above embodiment can be obtained. The synchronous motor 10 can be properly activated without using any special circuitry and without locking the rotor independent of whether the synchronous motor 10 is rotated in the first rotational direction CW or in the second rotational direction CCW.

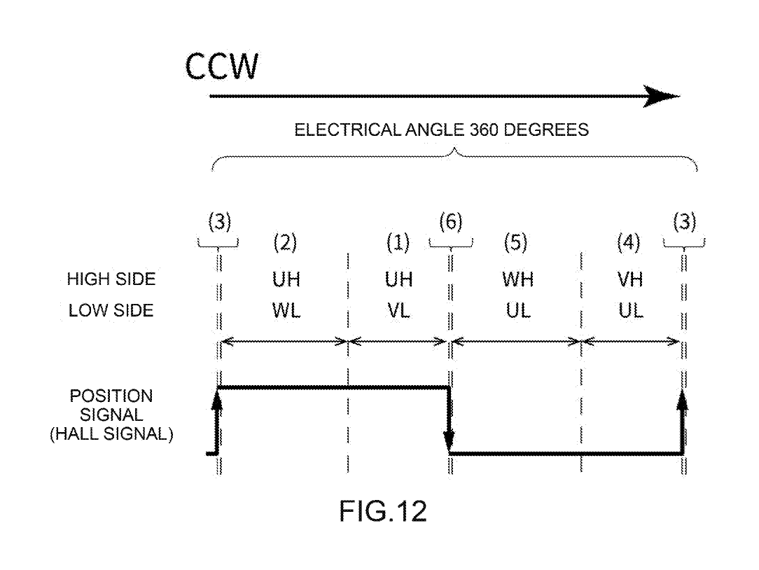

FIG. 12 is the second diagram for describing the activation control in a variation of the present embodiment.

Note that, in the present variation, in the activation control when the synchronous motor 10 is rotated in the second rotational direction CCW, the particular energization patterns, in the normal operation include the third energization pattern (3) switched when the rising edge of the position signal Hu has arrived, and the sixth energization pattern (6) switched when the falling edge has arrived so that the energization pattern may be switched in the reverse order. That is, as illustrated in FIG. 12, when the rising edge of the position signal Hu arrives, the energization pattern is switched to the third energization pattern (3), and then immediately switched to the second energization pattern (2). Subsequently, after the lapse of a certain time, the energization time is switched to the first energization pattern (1), and the first energization pattern (1) is continued until the falling edge of the position signal Hu arrives. When the falling edge of the position signal Hu arrives, the energization pattern is switched to the sixth energization pattern (6), and then immediately switched to the fifth energization pattern (5). Subsequently, after the lapse of a certain time, the energization time is switched to the fourth energization pattern (4), and the fourth energization pattern (4) is continued until the rising edge of the position signal Hu arrives.

### [Others]

The motor drive control device is not limited to a circuit configuration shown in the above embodiment and its variation. Various circuit configurations configured to fit for the purpose of the present disclosure can be applied.

For example, an arrangement position of the position detector is not limited. That is, the relationship between the reference timing corresponding to the variation of the phase of the position signal and the energization pattern corresponding to the reference timing is not limited to the above embodiment. A motor for detecting the rotational speed of the motor using an FG sensor, etc., for example, can be a driving control object of the motor drive control device in the present embodiment.

During the activation period of the motor in the above embodiment, with both timings, when the rising edge of the position signal is detected and when the falling edge of the position signal is detected as reference timings, the energization pattern is switched to the energization pattern corresponding to the reference timing, however, the present disclosure is not limited to this embodiment. With any one of the timings when the rising edge of the position signal is detected and when the falling edge of the position signal is detected as a reference timing, the energization phase may be switched to the energization phase corresponding to the reference timing.

In the acceleration determination process in the above embodiment illustrated based on FIG. 8, the evaluation value is added to or subtracted from the acceleration/deceleration counter C2, to weight the acceleration/deceleration determination value. However, in some cases, the acceleration/deceleration determination value may not be weighted.

In the above embodiment, the switching element constituting the inverter circuit 2 is MOSFET, but not limited to MOSFET, and may be a bipolar transistor.

The energization system of the motor (for example, 120-degree energization system) and the waveform (for example, square wave) of the drive signal energizing the coil are not limited in particular.

The above-described flowcharts each illustrate an example for describing the operation, and are not limited to the example. The steps illustrated in each flowchart are specific examples, and the embodiment is not limited to this step. For example, order of steps may be varied, another process may be inserted between steps, and the processes may be performed in parallel.

A part of all of the processes in the above embodiment may be performed by software, or may be performed by a hardware circuit. For example, the control unit is not limited to the microcomputer. The configuration inside the control unit may be processed at least in part by software.

The above-described embodiment should be considered in all respects to be illustrative and not restrictive. The scope of the present disclosure is indicated by the appended claims rather than the foregoing description, and all changes that come within the meaning and range equivalent to the claims are intended to be included therein.

What is claimed is:

1. A motor drive control device comprising:
a motor drive unit configured to selectively energize three-phase coils of a motor;
one position detector configured to output a position signal for varying a phase corresponding to a position of a rotor of the motor; and
a control circuit unit configured to output a drive control signal to the motor drive unit to switch six energization patterns for energizing the three-phase coils by use of the motor drive unit in a predetermined order according to a variation of the phase of the position signal,
wherein during an activation period of the motor, the control circuit unit performs activation control so that an energization time of one or more particular energization patterns corresponding to a rotational direction of the motor is shorter than an energization time of each of the other energization patterns.

2. The motor drive control device according to claim 1, wherein
every time a predetermined reference timing corresponding to a variation of the phase of the position signal arrives, the control circuit unit switches of the energization pattern a plurality of times with reference to the timing, and
the particular energization patterns include an energization pattern switched subsequent to an energization pattern when the reference timing arrives.

3. The motor drive control device according to claim 1, wherein
the energization time of each of the particular energization patterns when the activation control is performed is a time set in advance.

4. The motor drive control device according to claim 1, wherein
the control circuit unit includes an accelerating condition determination unit configured to determine, based on the position signal, whether a rotation of the motor is in a predetermined accelerating condition when the activation control is performed, and
after the accelerating condition determination unit determines that the rotation of the motor is in the predetermined accelerating condition, the control circuit unit reduces a ratio of the energization time of each of the particular energization patterns to the energization time of each of the other energization patterns compared to the ratio obtained when the activation control is performed.

5. The motor drive control device according to claim 4, wherein
the accelerating condition determination unit
measures a time corresponding to a period of the position signal to determine whether the rotation of the motor is more accelerated than the rotation previously measured,
increases a determination value when determining that the rotation of the motor is accelerated,
decreases the determination value when determining that the rotation of the motor is not accelerated, and
determines whether the rotation of the motor is in a predetermined accelerating condition based on a result of comparison between the determination value and a predetermined acceleration determination threshold.

6. The motor drive control device according to claim 4, wherein
the control circuit unit includes:
an energization switching signal output unit configured to output an energization switching signal corresponding to the timing when the energization pattern is switched based on the position signal;
a motor control unit configured to output the drive control signal to the motor drive unit based on the energization switching signal to switch the energization pattern; and
an acceleration determination unit configured to determine, based on the energization switching signal, whether the rotation of the motor is in the predetermined accelerating condition and output an acceleration determination signal based on the determined result,
wherein the motor control unit performs a normal operation of the motor when the acceleration determination signal corresponding to the determined result indicating the predetermined accelerating condition is output when the activation control is performed.

7. A method of driving a motor using a motor drive control device comprising a motor drive unit configured to selectively energize three-phase coils of the motor and one position detector configured to output a position signal for varying a phase corresponding to a position of a rotor of the motor, to switch six energization patterns for energizing the three-phase coils by use of the motor drive unit in a predetermined order according to a variation of the phase of the position signal, the method comprising:
performing, during an activation period of the motor, activation control so that an energization time of one or more particular energization patterns corresponding to a rotational direction of the motor is shorter than an energization time of each of the other energization patterns; and
after the activation control is performed, reducing a ratio of the energization time of each of the particular energization patterns to the energization time of each of the other energization patterns compared to the ratio obtained when the activation control is performed.
